(19) United States
(12) Patent Application Publication
(10) Pub. No.: US 2012/0228287 A1
(43) Pub. Date: Sep. 13, 2012

(54) MOBILE DEVICE FOR RENDERING HARMLESS ORGANIC WASTE, PARTICULARLY MEDICAL, CATERING AND VETERINARY WASTE

(75) Inventor: Ryszard PAROSA, Wroclaw (PL)

(73) Assignee: ATON-HT S.A., Wroclaw (PL)

(21) Appl. No.: 13/465,193

(22) Filed: May 7, 2012

Related U.S. Application Data
(63) Continuation of application No. PCT/PL2010/000111, filed on Nov. 5, 2010.

(30) Foreign Application Priority Data
Nov. 6, 2009 (PL) 389497

(51) Int. Cl. H05B 6/80

(52) U.S. Cl. 219/683; 219/756; 219/759

(57) ABSTRACT

The present disclosure concerns a mobile device for rendering harmless organic waste, particularly medical, catering and veterinary waste, including harmful waste, to be used to render the waste harmless by means of the process of carbonization directly in the vicinity of its production. A mobile device for rendering harmless organic waste, particularly medical, catering and veterinary waste, having at least two chambers and devices to recover heat, according to the disclosure is characterized in that it constitutes a carbonization reactor unit connected at its outlet to an exhaust gases after-burning reactor, placed in a mobile container and having microwave generators as its heating devices.

### CROSS-REFERENCE TO RELATED APPLICATIONS

This application is a continuation of PCT/PL2010/000111 filed on Nov. 5, 2010, which claims the benefit of P.389497 filed on Nov. 6, 2009. The disclosures of the above applications are incorporated herein by reference.

### FIELD

The present disclosure concerns a mobile device for rendering harmless organic waste, particularly medical, catering and veterinary waste, including harmful waste, to be used to render the waste harmless.

### BACKGROUND

The statements in this section merely provide background information related to the present disclosure and may not constitute prior art.

The Chinese patent application CN2877705 Y (published on 14 Mar. 2007) discloses a vehicle for utilization of dangerous substances containing infection diseases agents, equipped with an incineration unit, a sterilization device, a sewage collection and treatment device and an electric supply system, combined into one complete set of equipment. The incineration unit works on the basis of two-pass incineration. The sterilization device generates high pressure steam using the heat from incineration and has a two-chamber construction. The vehicle is fully functional while being driven and can function as a rescue unit in case of epidemics.

The Japanese patent application JP10019223 A (published on 23 Jan. 1998) teaches an incineration assembly comprising a waste feeding device, an exhaust fan, a rotary oven, etc., as well as an auxiliary unit for the treatment of combustion and exhaust gases having an auxiliary incineration device, a recovery boiler to recover heat from the waste incineration, a dust collector, an exhaust fan and the like. The units are mounted on mobile frames connected to the base and mutually joined only by means of gas conduits. They could be assembled at the site of work and are suitable to be transported in containers.

The Japanese patent application JP3241217 A (published on 28 Oct. 1991) teaches a vehicle for the waste incineration having an automatic feeding device for the incinerated object and an automatic device for the slag removal. After the incinerated object has been pushed into the incineration chamber by the automatic feeding device, it is incinerated in the double incineration chamber by means of two burners, and its remains are passed to the automatic device for the slag removal.

Furthermore, the American patent application US2006219139 A1 (published on 5 Oct. 2006) discloses a mobile system comprising a container, at least one gasification chamber, and combustion chamber for burning the produced combustible gas, wherein the system can include a control room. Waste material is loaded into a suspended mesh cage that is offset away from the walls of the gasification chamber. Produced fuel gases are drawn from the gasification chamber into the produced fuel gas combustion chamber. The produced fuel gas combustion chamber may comprise a maze ignition chamber for the ignition of said fuel gases.

Known mobile devices for rendering harmless organic waste, particularly medical waste, constitute expensive vehicles which could not be left without supervision, or complex and expensive incineration units to incinerate, assembled only at the working site. Known incineration systems utilize gas heating or induction electric heating, which are not economical. Known container systems are not suitable to render harmless the harmful medical waste.

### SUMMARY

The present disclosure provides a mobile device for rendering harmless organic waste, particularly medical, catering and veterinary waste including harmful waste, to be used to render the waste harmless by means of the process of carbonization directly in the vicinity of its production, without drawbacks of the known constructions of this kind. In particular, the device is economical, simple and cheap. It works practically without supervision, is easy to transport and ready to work at any time after connecting to the mains.

According to the present disclosure, a mobile device is provided for rendering harmless organic waste, particularly medical, catering and veterinary waste, having at least two chambers and devices to recover heat, characterized by that it constitutes a carbonization reactor unit connected at its outlet to an exhaust gases afterburning reactor, placed in a mobile container, and having microwave generators as its heating devices.

Advantageously, the carbonization reactor comprises a metal chamber with internal walls of ceramic material with low absorption rate of electromagnetic radiation in the frequency range from 300 MHz to 3 GHz, whereas the metal chamber of the carbonization reactor advantageously includes at least two microwave radiators, fixed to its walls, connected to microwave generators having working range from 300 MHz to 3 GHz.

The waste heated in the metal chamber has basically the temperature from 600° C. to 850° C.

The exhaust gases after-burning reactor advantageously comprises an exhaust of pirolitic exhaust gases from the metal chamber of the carbonization reactor.

The exhaust gases after-burning reactor advantageously comprises also at least two microwave radiators mounted in its walls, connected to microwave generators having working range from 300 MHz to 3 GHz.

Additionally, the exhaust gases after-burning reactor advantageously comprises a bed in the form of hot ceramic profiles having the temperature from 1000° C. to 1500° C., made of material with high absorption rate of electromagnetic radiation in the frequency range from 300 MHz to 3 GHz, with the loss tangent δ>10⁻¹ at the temperature from 1000° C. to 1500° C., whereas, advantageously, the bed is made of ceramic profiles from the granulate of material chosen from the group comprising zirconium oxide (ZrO), silicon carbide (SiC), aluminium trioxide (Al₂O₃), barium carbide (BaC) and hafnium carbide (HfC).

The flow of gases in the bed is advantageously a turbulent one.

Apart from the above, the exhaust gases after-burning reactor includes multilayer heat isolation made of material with low absorption rate of electromagnetic radiation in the frequency range from 300 MHz to 3 GHz, with the loss tangent 6>10⁻² at the temperature from 1000° C. to 1500° C.

Advantageously, the exhaust gases after-burning reactor includes also an additional air supply.

Advantageously, the container comprises at least one heat exchanger in the circuit of heat recovery from the after-burned exhaust gases.

Advantageously, the container comprises also a control unit having a microprocessor controller.

Advantageously, the container further comprises a service line of medium, in the form of water or air, from the circuit of heat recovery from the after-burned exhaust gases.

In the front part of the container there is advantageously a waste shredding unit.

Advantageously, in the bottom part of the container there is a transport device for shredded waste.

Advantageously, in the bottom part of the container there is also a drawer for solid products of carbonization.

### DRAWINGS

The present invention has been presented in detail in advantageous examples of its embodiments with reference to the attached drawings, in which:

FIG. 1 presents a block diagram of the device according to the present invention;

FIG. 2 presents schematically the construction of the present device in anaxonometric view;

FIG. 3 presents schematically the carbonization reactor in the longitudinal cross-section;

FIG. 4 presents schematically the exhaust gases after-burning reactor in the longitudinal cross-section; and

FIG. 5 presents an external view of the device according to the present disclosure.

### DETAILED DESCRIPTION

The following description is merely exemplary in nature and is not intended to limit the present disclosure, application, or uses.

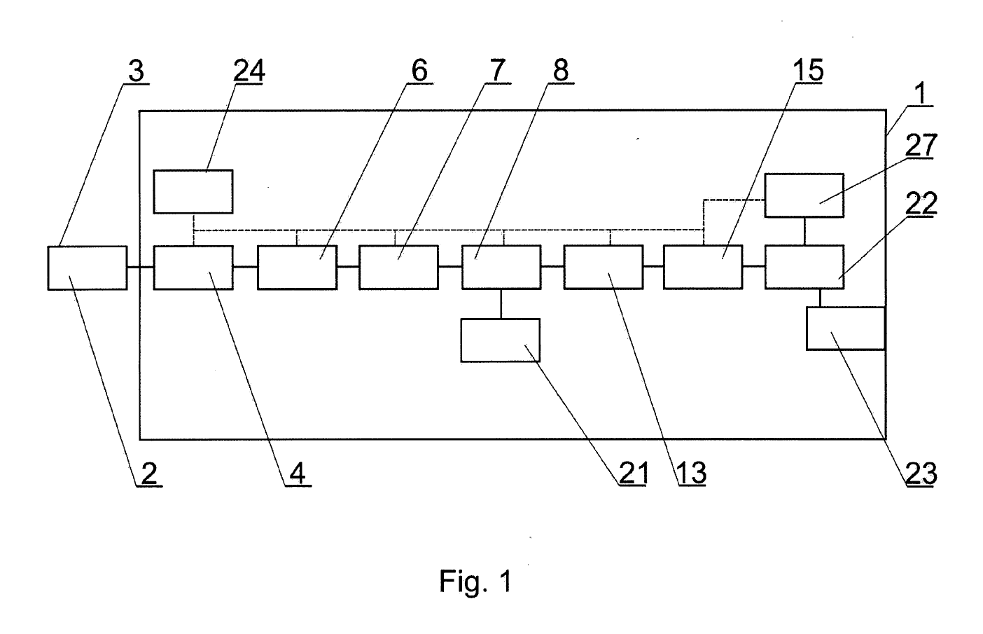

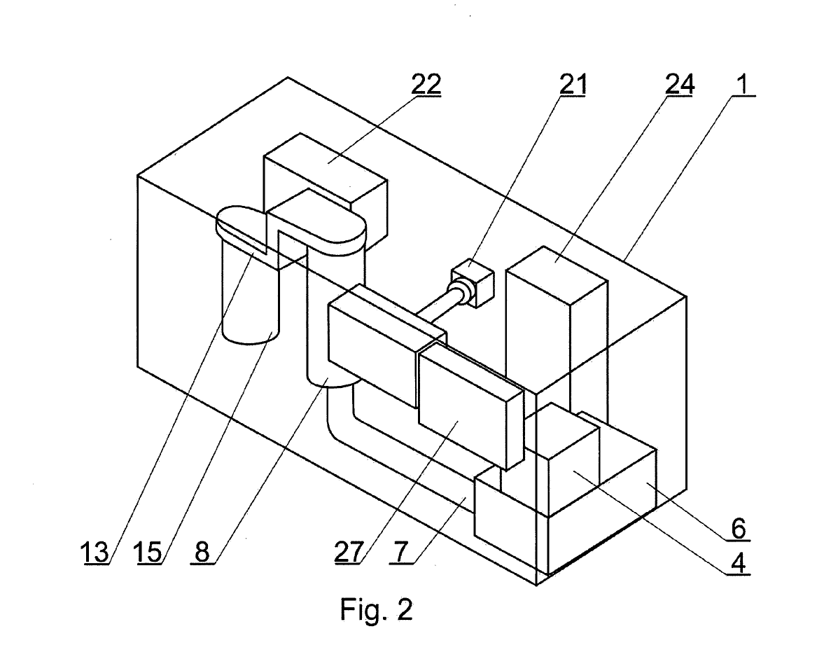

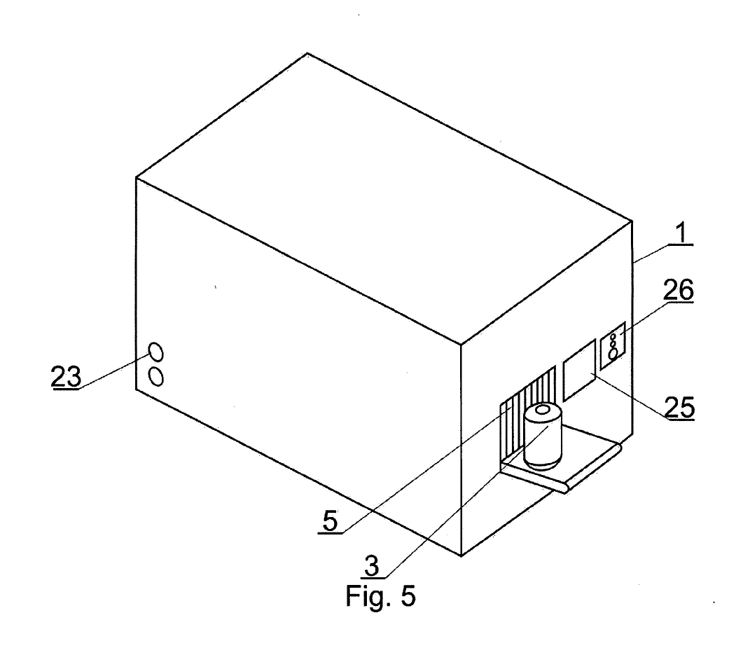

As it has been shown in the FIG. 1 and FIG. 2, and also in the FIG. 5, the whole device is closed in a typical transport container 1 and it constitutes a carbonization reactor unit connected at its outlet to an exhaust gases after-burning reactor, and having microwave generators as its heating devices. Medical waste 2 in plastic bag 3 (see FIG. 5) is dropped into the chute 4 through the window 5 in the front wall of the container 1, and is passed into the waste shredding unit 6, having conventional construction, situated in the front part of the container at its bottom.

The shredded medical waste is carried to the carbonization reactor 8 by means of the known transport device 7 for shredded waste, which can constitute a screw conveyor.

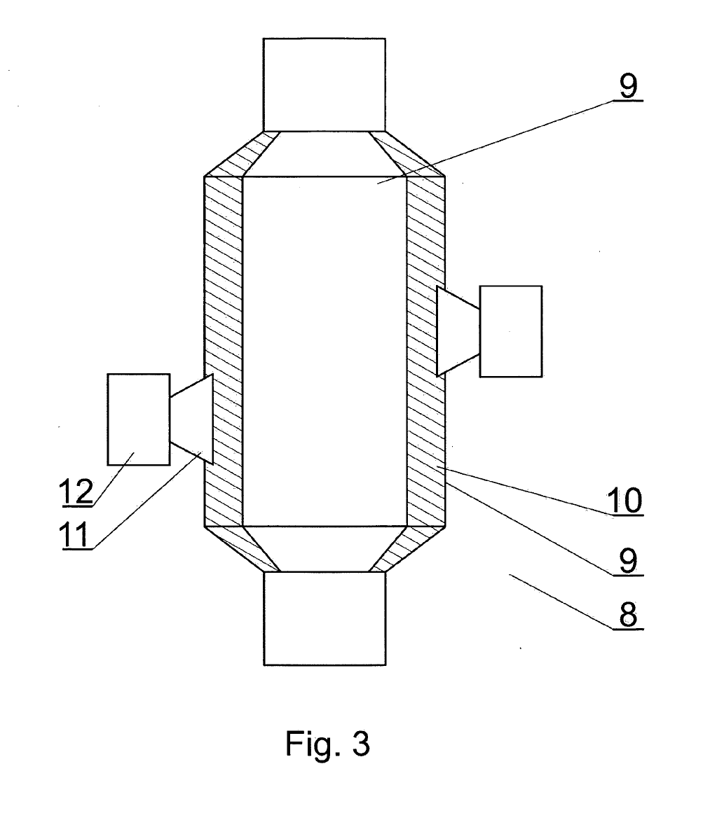

As it has been shown in the FIG. 3, the carbonization reactor 8 comprises the metal chamber 9 with internal walls 10 of ceramic material with low absorption rate of electromagnetic radiation in the frequency range from 300 MHz to 3 GHz, whereas the metal chamber 9 of the carbonization reactor 8 advantageously includes at least two microwave radiators 11, fixed to its walls, connected to microwave generators 12 having working range from 300 MHz to 3 GHz.

The medical waste 2 heated in the metal chamber 9 has basically the temperature from 600° C. to 850° C.

The pirolitic exhaust gases pass, by means of a typical exhaust 13 (invisible in the FIG. 2) from the metal chamber 9 of the carbonization reactor 8 to the metal chamber 14 of the exhaust gases after-burning reactor 15. The pirolitic exhaust gases pass, by means of a typical exhaust 13 (invisible in the FIG. 2) from the metal chamber 9 of the carbonization reactor 8 to the metal chamber 14 of the exhaust gases after-burning reactor 15.

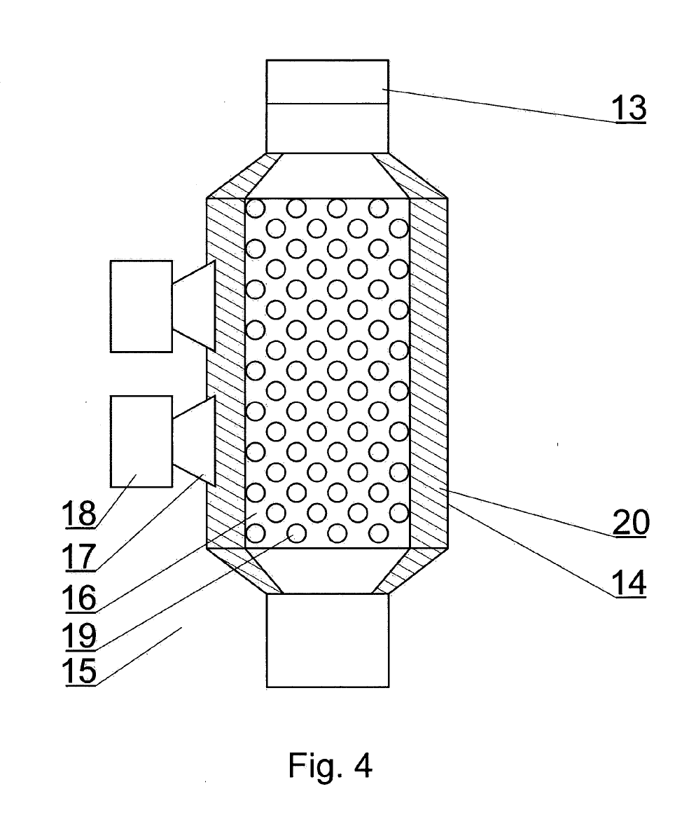

As it has been shown in the FIG. 4, the reactor 15 is in the form of a metal container (similarly to the carbonization reactor 8) having the metal chamber 14 with the bed 16 of a porous material, and having an inlet and an outlet of the exhaust gases. The flow of gases in the bed 16 is a turbulent one. The exhaust gases after-burning reactor 15 has two microwave radiators 17 mounted in its cylindrical side wall—as in this example of embodiment the container is of the cylindrical shape, connected to microwave generators 18 (with a water cooling system) and comprises a bed 16 in the form of hot ceramic profiles 19 having the temperature from 1000° C. to 1500° C., made of material with high absorption rate of electromagnetic radiation in the frequency range from 300 MHz to 3 GHz, with the loss tangent δ>10⁻¹ at the temperature from 1000° C. to 1500° C. Furthermore, the exhaust gases after-burning reactor has also an additional air supply.

The exhaust gases after-burning reactor includes a multilayer heat isolation 20 made of material with low absorption rate of electromagnetic radiation in the frequency range from 300 MHz to 3 GHz, with the loss tangent 6>10⁻² at the temperature from 1000° C. to 1500° C., wherein the microwave radiators 17 are situated in such a way as to radiate electromagnetic energy through the heat isolation 20.

The bed 16 is made of ceramic profiles 19 from the granulate of material chosen from the group comprising zirconium oxide (ZrO), silicon carbide (SiC), aluminum trioxide (Al₂O₃), barium carbide (BaC) and hafnium carbide (HfC).

In this embodiment ceramic profiles 19 of the bed 16 constitute ceramic balls with the diameter from 2 mm to 20 mm. The bed 16 can comprise, instead of or besides balls, cubes with the dimensions from 4 mm to 30 mm and/or porous cubical tiles with holes having the diameter from 2 mm do 15 mm, rings with the diameter of 20 mm and thickness of about 6 mm, and other profiles.

Functioning of the exhaust gases after-burning reactor 15 consist in that, during the process of after-burning, the polluted gas passes through the bed of ceramic balls or other ceramic profiles heated to the high temperature. The after-burning of impurities, mainly hydrocarbons and some other chemical compounds (e.g. carbon monoxide CO), and also coal dust, takes place in the gas that is heated by the balls, owing to the presence of oxygen. In the case of insufficient content of oxygen it can be metered in the pure form, as air or—in some cases—as ozone (O₃).

As it has been shown in the FIG. 1 and FIG. 2, in the bottom part of the container there is also a drawer for solid products of carbonization, and the solid products of carbonization are collected from the drawer periodically. The solid products of carbonization contain less than 1% of organic carbon and, depending on the type of waste, constitute 4 to 15% of the charged volume of the medical waste.

Gases from the exhaust gases after-burning reactor 15 pass to the bank of heat exchangers 22 placed in the circuit of heat recovery from the after-burned exhaust gases. This circuit, at its side adjacent to the device, ends with a service line 23 of medium, in the form of water or air, from the circuit of heat recovery from the after-burned exhaust gases.

The whole process is controlled by the control unit 24 having a microprocessor controller situated in the container 1. In the front wall of the container 1 there is a dialog window 25 of the control unit 24 and the push buttons panel 26 (see FIG. 5).

To prevent the recombination of toxic dioxins and furans, rapid cooling of gases in the cooler 27 is employed, at limited access to metallic ions having catalytic effect. Then, some specially designed absorption devices can be used to absorb ions Cl⁻.

What is claimed is:

1. A mobile device for rendering harmless organic waste, particularly medical, catering and veterinary waste, having a first chamber and a second chamber and devices to recover heat, wherein the first chamber comprises a carbonization reactor unit connected at its outlet to the second chamber, characterized in that the second chamber comprises an after-burning reactor for burning exhaust gases, wherein all chambers, devices to recover heat and all auxiliary devices are placed in one mobile container being a typical transport container, and wherein both chambers are having microwave generators as its heating devices.

2. The mobile device according to claim 1, characterized in that the carbonization reactor comprises a metal chamber with internal walls made of ceramic material with low absorption rate of electromagnetic radiation in a frequency range from 300 MHz to 3 GHz.

3. The mobile device according to claim 2, characterized in that the metal chamber of the carbonization reactor includes at least two microwave radiators, fixed to its walls, connected to microwave generators having a working range from 300 MHz to 3 GHz.

4. The mobile device according to claim 2, characterized in that the waste heated in the metal chamber of the carbonization reactor has a temperature from 600° C. to 850° C.

5. The mobile device according to claim 2, characterized in that the after-burning reactor for burning exhaust gases comprises an exhaust of pyrolytic exhaust gases from the metal chamber of the carbonization reactor.

6. The mobile device according to claim 1, characterized in that the exhaust gases after-burning reactor comprises at least two microwave radiators mounted in its walls, connected to microwave generators having a working range from 300 MHz to 3 GHz.

7. The mobile device according to claim 1, characterized in that the after-burning reactor for burning exhaust gases comprises a bed in the form of hot ceramic profiles having a temperature from 1000° C. to 1500° C., made of material with a high absorption rate of electromagnetic radiation in a frequency range from 300 MHz to 3 GHz, with a loss tangent δ>10⁻¹ at a temperature from 1000° C. to 1500° C.

8. The mobile device according to claim 7, characterized in that the bed is made of ceramic profiles from the granulate of material selected from the group consisting of zirconium oxide (ZrO), silicon carbide (SiC), aluminium trioxide (Al₂O₃), barium carbide (BaC) and hafnium carbide (HfC).

9. The mobile device according to claim 7, characterized in that a flow of gases in the bed is turbulent.

10. The mobile device according to claim 1, characterized in that the after-burning reactor for burning exhaust gases includes multilayer heat isolation made of material with low absorption rate of electromagnetic radiation in a frequency range from 300 MHz to 3 GHz, with a loss tangent δ>10⁻² at a temperature from 1000° C. to 1500° C.

11. The mobile device according to claim 1, characterized in that the after-burning reactor for burning exhaust gases includes an additional air supply.

12. The mobile device according to claim 1, characterized in that in the container there is at least one heat exchanger in a circuit of heat recovery from the after-burned exhaust gases.

13. The mobile device according to claim 1, characterized in that in the container there is a control unit having a microprocessor controller.

14. The mobile device according to claim 1, characterized in that in the container there is a service line of medium, in the form of water or air, from the circuit of heat recovery from the after-burned exhaust gases.

15. The mobile device according to claim 1, characterized in that in a front part of the container there is a waste shredding unit.

16. The mobile device according to claim 1, characterized in that in a bottom part of the container there is a transport device for shredded waste.

17. The mobile device according to claim 1, characterized in that in a bottom part of the container there is a drawer for solid products of carbonization.
